(19) United States
(12) Patent Application Publication
(10) Pub. No.: US 2019/0139007 A1
(43) Pub. Date: May 9, 2019

(54) METAL-BACKED DIGITAL CURRENCY

(71) Applicant: METAL CONVERTIBILITY (MCON) LLC, Miami Beach, FL (US)

(72) Inventor: Richard W. Rahn, Great Falls, VA (US)

(21) Appl. No.: 16/160,303

(22) Filed: Oct. 15, 2018

Related U.S. Application Data
(60) Provisional application No. 62/572,988, filed on Oct. 16, 2017.
(60) Provisional application No. 62/742,605, filed on Oct. 8, 2018.

(51) Int. Cl. G06Q 20/06; H04L 9/32

(52) U.S. Cl. CPC G06Q 20/065; G06Q 2220/00; H04L 2209/56; H04L 9/3213

(57) ABSTRACT

Disclosed is a system and method for managing and administering an base non-ferrous metal-backed digital currency comprising an issuing entity, a warehousing entity, and a control entity, the issuing entity enabled to issue and redeem digital tokens representing a set quantity of said metals, the warehousing entity enabled to receive and dispense said metals and the control entity enabled to direct the issuing and redemption of tokens by the issuing entity and the receiving and dispensing of said metals by the warehousing entity.

### CLAIM OF PRIORITY

This application is being filed as a non-provisional patent application under 35 U.S.C. § 111(a) and 37 CFR § 1.53(b). This application claims priority under 35 U.S.C. § 119(e) to U.S. provisional patent application Ser. No. 62/572,988 filed on Oct. 16, 2017, and U.S. provisional patent application Ser. No. 62/742,605 filed on Oct. 8, 2018, the contents of which are incorporated herein by reference.

### TECHNICAL FIELD

This invention relates generally to financial currency systems and more particularly to systems and methods for managing and administering a medium of economic exchange.

### BACKGROUND OF THE INVENTION

The present invention relates to systems and methods to create and operate a digital token, akin to a cryptocurrency, which is backed by base non-ferrous metals. The token of the present invention may be traded on both centralized and decentralized exchanges, and enables privately owned base non-ferrous metal assets to be tokenized so that ownership can be transferred without requiring to physically transport the assets.

Metals suitable for the system and method of the present invention include: aluminum, copper, tin, nickel, zinc, and lead. As used hereinafter, the term “base non-ferrous metals” or, simply, “metals” shall refer to this particular group of metals.

Ever since the major countries of the world abandoned the gold standard, global commerce suffers from constantly fluctuating exchange rates between countries and persistent and highly variable rates of inflation. These problems have undermined savings, investment, and trade, and reduced gross domestic product growth, employment, and real wage growth.

Nobel Laureate, F. A. Hayek, in his classic, “Denationalization of Money: The Argument Refined” published in 1976, explained why it is preferable and practical to have non-government issued money, such as the token of the present invention.

Through the object of the present invention—a base non-ferrous metal-backed digital token (hereinafter the “Token”)—private parties can use metals as a method of exchange. Prices for all other commodities and goods and services might be listed in kilograms of a base non-ferrous metal rather than in U.S. dollars, Euros, UK pounds, Japanese yen, or any other government-issued money.

The Case for Non-Ferrous Metals:

Gold, for many good reasons, has served as the most commonly used commodity standard for money. It served the global economy well from the time the UK first adopted it in 1821 until 1914. In the 1870s, gold was also adopted by Germany, France, the United States, and many other countries, making it a global currency in which there were no exchange rates between countries, and there was no persistent inflation. This was an economic golden age in which the world economy grew rapidly.

The object of the current invention—a Token system backed by base non-ferrous metals—is nevertheless superior to gold. For gold to work again as money, the major economies would have to all agree at the same time on the price at which their existing government currencies would be exchanged for a fixed unit of gold—a most difficult undertaking.

Governments would likely reject going back to gold as a universal standard because it eliminates their ability to monetize—a power that these governments are unlikely to give up. For example, the U.S. Treasury has been aggressive in shutting down private issuers of gold money (both coin and digital gold money) as violating the Treasury's asserted monopoly right to issue money. The U.S. government also places a capital gains tax on any gain in the price of gold coins and bullion versus the U.S. dollar, even when the fall of the dollar is solely due to inflation.

The price of gold has been more volatile than those of base non-ferrous metals and other commodities over the past thirty years, partly because of world events and partly because governments own more than a fifth of the outstanding world stock of gold and because of the actions of governments, such as gold sales and purchases by governments, which lead to volatility.

In contrast, the object of the present invention—a base non-ferrous metal-backed digital token system—overcomes many of the problems with gold, while sharing many of its advantages. Like gold, base non-ferrous metals are reasonably non-perishable. And some, like aluminum and copper, are recyclable.

In the past, gold had the attraction that a tiny amount was of great value, so gold proved useful for high-value coins. This advantage disappears in the digital age and, in fact, can be a disadvantage. Because of its high value-to-weight, gold is easily stolen, which makes it costly to store. It is much more difficult to steal a significant value of base non-ferrous metal because of its low value-to-weight.

Base non-ferrous metals have broad utility. And their price volatility should continue to decline as their global inventories grow relative to new production. And this also prevents any one entity from cornering the market: because of the huge global stock of these metals, and because producers in many countries can ramp up production. Base non-ferrous metals are also found in abundance and can be mined and produced in many different countries.

Considering the above, it is apparent that a need exists for a Token that possesses none of the deficiencies of government-issued fiat money and does not face the obstacles to implementation that currently plague a return to gold. The object of the present invention fulfills that need.

### SUMMARY OF THE INVENTION

The invention includes a system and method for the creation of a global base non-ferrous metal-backed digital Token.

Described is a method of facilitating the broad ownership and bartering of metals using a digital token backed by base non-ferrous metal reserves where each Token would be equal to a fixed weight and grade of metal. Through tokenization, this invention broadens the ownership and utility of metal assets. Analogous to other “sharing economy” ideas, such as ride sharing services that put to work idle transportation assets, and online services that allows computer owners to rent out their CPU computing power, this invention takes base metal inventories, that would otherwise be idle, and facilitates their use as a hedge, a means of exchange, and a source of funding.

The use of metals as a means of exchange, however, does not make it analogous to “money.” Money, specifically, implies a centralized medium through which the exchange of goods and services is facilitated. The exchange of metals for goods and services is a peer-to-peer transaction that is more accurately defined as a “barter.” This is especially true given that all such exchanges are purely voluntary, and not legally compulsory, as is the case with national currencies that are designated as “legal tender.”

The present invention provides for the full and practical convertibility of metals to tokens and back via a “dual entity structure” implementation. In this respect, this invention differs from other “asset-backed cryptocurrencies.” Tokens backed by real estate, for example, cannot be converted due to the inability to partition the underlying asset. Tokens backed by commodity baskets, for example, present the holder with the task of taking delivery of warrants which are deliverable at multiple locations. Such tokens, in practice, present logistical obstacles that make them non-convertible. This invention, via the establishment of a stand-alone company, distinct from the Token system, whose purpose is to accept the Token in exchange for the underlying metal, provides a clear process that allows actual conversion in practice.

An important element of the system is the Standards Board, within the stand-alone company, which maintains the integrity of the Token, and guarantees the redemption of Tokens for the equivalent quantity of physical metals at the discretion of the Token holders. This Board is not to be confused with a “centralized” body seeking to act as a “trusted third party” involved in the activities of Token holders. The Board governs only the rules and integrity of the exchange of Tokens for metal from the stand-alone company's reserves warehouse network.

As such, the Standards Board is more like one side of a peer-to-peer transaction rather than a mediator between economic entities. The Board will utilize various techniques to maintain the viability and proper functioning of the convertibility mechanism. One such technique is the stamping of each Token by the originating warehouse in order to be able to trace each Token to its source, thereby preventing the proliferation of fraudulent tokens. Another method is a “canary algorithm” that utilizes statistical methods to generate random conversions that test the viability and proper functioning of the convertibility mechanism.

There are significant differences between the system and method of the present invention and futures contracts, like those traded on major exchanges such as the London Metals Exchange and NYMEX. This invention proposes a Token that is transferable peer-to-peer, as opposed to futures which depend on a centralized exchange. This invention proposes a Token that is directly convertible into the underlying physical metal, whereas futures deliver a warrant, which, itself, is then converted into physical metal. And, the warrants used by futures exchanges are each tied to a specific lot of metal at a specific location. The Token proposed by this invention is a general claim on any of the metal stored at any of the warehouses in the reserves network.

The advantages of a non-ferrous metal-backed Token system include:

1) Certainty that the value of the Token will never fall below the production cost of the underlying metal for an extended period and will never go to zero which is not true of cryptocurrencies that have no real asset backing);

2) The near elimination of cost, delay, and risk of transfers of value using the Token system, both internationally and domestically;

3) The elimination of exchange risk and uncertainty due to freely fluctuating exchange rates with government currencies;

4) The inability of rogue governments to interfere with the Token;

5) The benefit Tokens provide to those who work in the base non-ferrous metals industry, and the additional tax revenue for governments with the expansion of those industries;

6) The stability the Token provides to the base non-ferrous metal industry by creating a demand for the product less subject to quickly changing global business conditions;

7) The total transparency to the real cost of goods and services if base non-ferrous metals were the benchmark, since their global price would be almost impossible to control;

8) The ability of individuals, businesses, and other institutions to have a real store of value which cannot be inflated away; and,

9) Additional stability and certainty with less risk to the global marketplace, real economic growth, and increased job creation.

These and other objects, features, and advantages of the present invention may be more clearly understood and appreciated from a review of the ensuing detailed description of the preferred and alternate embodiments and by reference to the accompanying drawings and claims.

### BRIEF DESCRIPTION OF THE DRAWINGS

FIG. 1 shows a schematic representation of the system of the present invention.

### DETAILED DESCRIPTION OF THE PREFERRED EMBODIMENT

While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

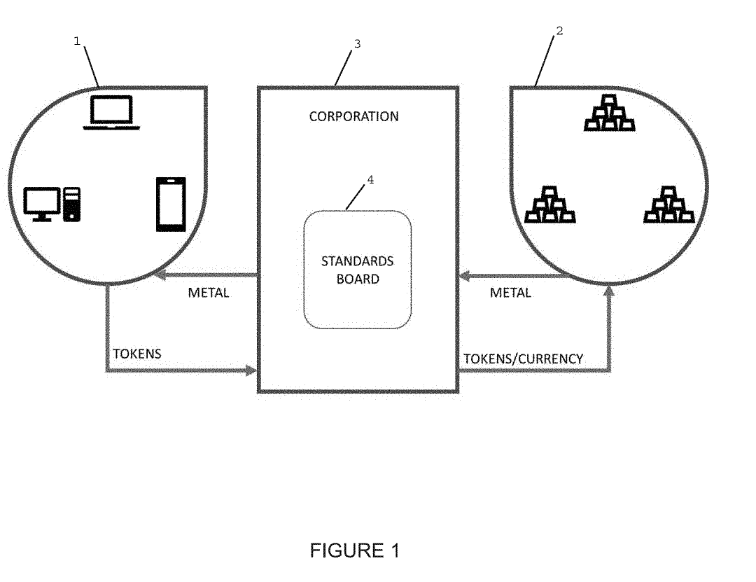

A clear understanding of the key features of the invention summarized above may be had by reference to the FIG. 1, which illustrates an embodiment of the method and system of the invention. However, it is not to be considered as limiting the invention's scope regarding other embodiments which the invention is capable of contemplating. Accordingly:

FIG. 1 describes the two distinct structures that, together, form the symbiotic relationship on which the Token functions. The first entity (or issue entity) (1) exists on a decentralized network (such as the internet) and will function similarly as many other cryptocurrencies. In fact, unless a Token holder decides to convert into physical metal, the Token is virtually the same as many other digital coins. However, the second entity (or warehousing entity) (2) provides the ability to redeem the Tokens for a fixed quantity, grade, and form of a designated base non-ferrous metal. The link between these two entities is the stand-alone corporation (or control entity) (3) which houses the Standards Board (or “Board”) (4) that either manages warehouses or arranges for the consignment of reserves in contracted independent warehouses. Through this model, the Token is imbued with an intrinsic value—that of the metal underpinning it—that makes it different from all other cryptocurrencies.

The system and method consists of the following elements:

A Token using its own distinctive symbol, utilizing “distributed ledgers” and other improvements in digital exchange and verification as they become available.

The Token is backed by base non-ferrous metal reserves.

A Standards Board is established to license firms who wish to issue the Token, according to rules and standards, including reserve requirements, and the required use of the Token name and corresponding symbol trademark. The duties of the Board might also be contracted out.

Token holders need to know that the value will not be “inflated away,” diluted, or otherwise destroyed. Thus, it is critically important that the Issuer act with the upmost integrity and maintain the promised reserves.

The Board will be within a private corporation whose members are individuals of recognized integrity and expertise. It will operate in a transparent manner so that interested parties, including government officials, will have access to the rules that govern the issuance of Tokens, including the fee schedule.

The powers of the Board include:

1) The licensing of the Token and other related distinctive symbols.

2) The licensing of Token issuers.

3) The determination of the reserves that issuers must keep.

4) Rules under which issuers must operate, in addition to reserve requirements, such as approving information and transfer systems both on centralized and decentralized trading platforms and networks.

5) Establishing rules and procedures for Token redemptions.

6) Establishing the rules for the period between request for redemption and physical delivery.

7) The power to make any necessary changes to rules and procedures due to unforeseen events, such as wars or natural disasters, or changes in international legal agreements or treaties that could affect the issuance, redemption, or exchange of Tokens.

An illustration of how the system and method of the present invention works in practice:

A base non-ferrous metal producer decides to become a licensed issuer of Tokens. The producer would obtain a license for a fee from the Board. The producer provides the metal reserves from its own assets and/or acquires additional reserves by purchasing them.

Alternatively, the issuer may utilize in-place assets that are deployed and in use as the reserve. For example, a power company could provide base non-ferrous metal in the form of electric transmission lines or other base non-ferrous metal assets to the licensed issuer at a price less than the present value of the scrap base non-ferrous metal at the time of ultimate redemption or replacement with other base non-ferrous metal assets, with the understanding that the power company would continue to have fill use of the assets.

The licensed issuer (the base non-ferrous metal company) could also be required to place a specified weight of base non-ferrous metal ingots in an approved warehouse as a primary reserve (such as those approved by the London Metals Exchange). This primary reserve would serve to fulfill any calls for redemption of the issued Tokens.

In the rare instance where the primary physical base non-ferrous metal reserves held by the licensed issuer (the base non-ferrous metal company) are insufficient to meet the demands for redemption, the power company would be called upon to provide the necessary base non-ferrous metals. Most likely, the power company would purchase the metals in the open market, but as a last resort would provide actual base non-ferrous metal products from their tokenized assets.

Users of the Token could choose to trade them on an exchange which has the advantage of being easy to use—with near real-time transactions on some platforms—but with the disadvantage of not being anonymous. Those exchanging directly would have the advantage of hack-proof anonymity without a third party controlling any funds.

The advantages of the base non-ferrous metal backed Token to all parties are as follows:

1) The ultimate purchaser and user of Tokens would own an actual asset, and limit their exposure to inflation and foreign exchange risk.

2) The issuer of Tokens would benefit from the float between what it paid for the reserves and the market price, and from their share of the fees. A base non-ferrous metal company which merely monetarizes its existing base non-ferrous metal assets, such as inventories and base non-ferrous metal ingots, would derive currently untapped liquidity from its sale of Tokens, which could then be used to fund operations.

3) Other companies that issue Tokens would have to purchase all their required reserves in the market and would profit from the difference between the cost of their metal reserves and the sale price of the Tokens. In this way, these companies would be acting much like a bank which makes money from the spread between the cost of its “funds” (base non-ferrous metal reserves) and the money it lends (the sale of Tokens).

4) The companies providing the base non-ferrous metal as a secondary reserve would have the benefit of immediately monetarizing assets in use (the sharing economy). This could be particularly attractive to base non-ferrous metal fabricators and scrap dealers, electric power companies, and other large owners of metal assets.

5) The Board would profit from fee revenues.

Accordingly, it will be understood that the preferred embodiment of the present invention has been disclosed by way of example and that other modifications and alterations may occur to those skilled in the art without departing from the scope and spirit of the appended claims.

What is claimed is:

1. A system for administering a metal-based currency comprising:
an issuing entity enabled to issue and redeem one or more tokens, each token representing a quantity of a base non-ferrous metal;
a warehousing entity enabled to receive and dispense said quantity of said base non-ferrous metal;
a control entity enabled to direct and control the token issuing and redemption activities of the issuing entity and the metal receiving and dispensing activities of the warehousing entity;
wherein upon receipt of said quantity of said base non-ferrous metal the warehousing entity is enabled to transmit a first notification to said control entity which, in response, transmits a direction to the issuing entity to issue said token; and
wherein upon redemption of one of said one or more tokens the issuing entity is enabled to transmit a notification to said control entity which, in response, transmits a direction to the warehousing entity to dispense said quantity of said base non-ferrous metal.

2. The system of claim 1, wherein said token is a digital token comprising a cryptocurrency.

1. The system of claim 2, further comprising a distributed ledger that tracks ownership of the token and the base non-ferrous metals represented by the token.

4. The system of claim 1, wherein said direction and control activities by the control entity are governed by a rules-based standards board.

5. A method for administering a metal-based currency comprising:
at an issuing entity issuing and redeeming one or more tokens, each token representing a quantity of a base non-ferrous metal;
at a warehousing entity receiving and dispensing said quantity of said base non-ferrous metal;
at a control entity directing and controlling the token issuing and redemption activities at the issuing entity and the metal receiving and dispensing activities at the warehousing entity;
wherein upon receipt of said quantity of said base non-ferrous metal the warehousing entity transmits a first notification to said control entity which, in response, transmits a direction to the issuing entity to issue said token; and
wherein upon redemption of one of said one or more tokens the issuing entity transmits a notification to said control entity which, in response, transmits a direction to the warehousing entity to dispense said quantity of said base non-ferrous metal.

6. The method of claim 5, wherein said token is a digital token comprising a cryptocurrency.

7. The method of claim 6, further comprising a distributed ledger that tracks ownership of the token and the base non-ferrous metals represented by the token.

8. The method of claim 5, wherein said direction and control activities by the control entity are governed by a rules-based standards board.
